(19) United States
(12) Patent Application Publication
(10) Pub. No.: US 2010/0199313 A1
(43) Pub. Date: Aug. 5, 2010

(54) METHOD OF PROVIDING IPTV SERVICE INFORMATION, HYBRID IPTV AND RECORDING MEDIUM THEREOF

(75) Inventor: Eun-hee RHIM, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/553,679

(22) Filed: Sep. 3, 2009

(30) Foreign Application Priority Data
Feb. 3, 2009 (KR) 10-2009-0008539

(51) Int. Cl. H04N 7/173; H04N 5/445

(52) U.S. Cl. 725/46; 725/116

(57) ABSTRACT

Provided are a method of providing personalized Internet protocol television (IPTV) service information that is based on user information, a hybrid IPTV for executing the method, and a computer readable recording medium having recorded thereon a program for executing the method. The method includes transmitting user information to an IPTV service server via an Internet protocol network, receiving personalized IPTV service information that is based on the user information from the IPTV service server, and displaying the personalized IPTV service information.

### CROSS-REFERENCE TO RELATED PATENT APPLICATION

This application claims priority from Korean Patent Application No. 10-2009-0008539, filed on Feb. 3, 2009, in the Korean Intellectual Property Office, the disclosure of which is incorporated herein in its entirety by reference.

### BACKGROUND OF THE INVENTION

1. Field of the Invention

Methods and apparatuses consistent with the present invention relate to providing Internet protocol television (IPTV) service information, and more particularly, to a method of providing personalized IPTV service information, a hybrid IPTV for executing the method, and a computer readable recording medium having recorded thereon a program for executing the method.

2. Description of the Related Art

A hybrid IPTV includes an IPTV receiving module together with a tuner for receiving terrestrial digital broadcasting, digital cable broadcasting or digital satellite broadcasting.

Such a hybrid IPTV independently has an IPTV function based on an IPTV service receiving module and a digital broadcasting receiving function based on a tuner. Thus, when a user watches a broadcast content by using the digital broadcasting receiving function, it is difficult to expect a link between IPTV program guide information received from an IPTV service server and the broadcast content that a user is currently watching.

### SUMMARY OF THE INVENTION

The present invention provides a method of providing personalized IPTV service information that is based on user information, a hybrid IPTV for executing the method, and a computer readable recording medium having recorded thereon a program for executing the method.

According to an aspect of the present invention, there is provided a method of providing IPTV service information, the method including transmitting user information to an IPTV service server via an Internet protocol network; receiving personalized IPTV service information that is based on the user information from the IPTV service server; and displaying the personalized IPTV service information.

The method may further include transmitting a transport stream to the IPTV service server via the IP network.

The displaying may include displaying the personalized IPTV service information on a screen on which a content is reproduced so that the personalized IPTV service information and the content overlap each other.

The content reproduced may be a broadcast content that a user is presently watching.

The personalized IPTV service information may include program guide information generated from electronic program guide (EPG) information detected from a transport stream uploaded from a plurality of hybrid IPTVs, according to a user preference profile and the channel information.

According to another aspect of the present invention, there is provided a hybrid IPTV including an IP network interface unit; an IPTV service information transceiver transmitting user information to an IPTV service server via the IP network interface unit, and receiving personalized IPTV service information that is based on the user information from the IPTV service server; and a displaying unit displaying the personalized IPTV service information received by the IPTV service information receiver.

The hybrid IPTV may further a receiver receiving a transport stream; and an uploading unit uploading the transport stream received by the receiver to the IPTV service server via the IP network interface unit.

The hybrid IPTV may further include a decoder decoding the transport stream received by the receiver, wherein the displaying unit may display the personalized IPTV service information on a screen on which broadcast content output from the decoder is reproduced so that the personalized IPTV service information and the broadcast content overlap each other.

According to another aspect of the present invention, there is provided a computer readable recording medium having recorded thereon a program for executing a method of providing IPTV service information, the method including transmitting user information to an IPTV service server via an IP network; receiving personalized IPTV service information that is based on the user information from the IPTV service server; and displaying the personalized IPTV service information.

### BRIEF DESCRIPTION OF THE DRAWINGS

The above and other aspects of the present invention will become more apparent by describing in detail exemplary embodiments thereof with reference to the attached drawings, in which:

FIG. 1 is a structural view of a network containing a hybrid IPTV and an IPTV service server, according to an exemplary embodiment;

FIG. 2 is a structural view of a network containing first through nth hybrid IPTVs and an IPTV service server, according to another exemplary embodiment;

FIG. 3 is an operational flowchart of a method of providing IPTV service information, according to an exemplary embodiment; and

FIG. 4 is an operational flowchart of a method of providing IPTV service information, according to another exemplary embodiment.

### DETAILED DESCRIPTION OF EXEMPLARY EMBODIMENTS

Hereinafter, the present invention will be described in detail by explaining exemplary embodiments with reference to the attached drawings.

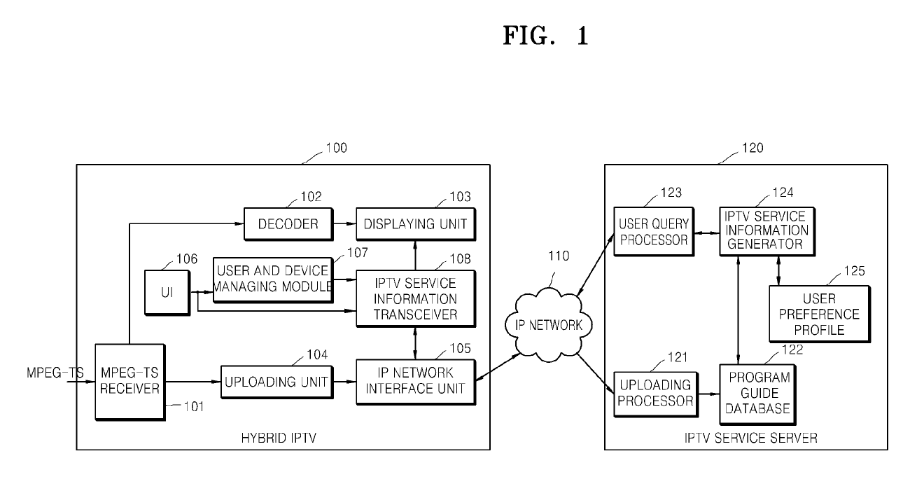

FIG. 1 is a structural view of a network containing a hybrid IPTV 100 and an IPTV service server 120, according to an embodiment of the present invention.

Referring to FIG. 1, the hybrid IPTV 100 may receive a moving picture expert group-transport stream (MPEG-TS) via a digital broadcast delivery network such as a public network, a satellite network or a cable network. The hybrid IPTV 100 may not only receive an IPTV service by bidirectional communication with the IPTV service server 120 via an IP network 110, but also receive personalized IPTV service information that is based on user information from the IPTV service server 120 and may display it. In addition, the hybrid IPTV 100 may upload the received MPEG-TS on the IPTV service server 120 via the IP network 110. The hybrid IPTV 100 may be a fixed apparatus installed in a fixed place or may be a portable apparatus.

As illustrated in FIG. 1, the hybrid IPTV 100 includes an MPEG-TS receiver 101, a decoder 102, a displaying unit 103, an uploading unit 104, an IP network interface unit 105, a user interface (UI) 106, a user and device managing module 107, and an IPTV service information transceiver 108.

The MPEG-TS receiver 101 receives the MEPG-TS via a broadcast delivery network such as a public network, a satellite network or a cable network. The MPEG-TS may be defined to have an MPEG2-2 TS packet format.

The decoder 102 decodes the MPEG-TS transmitted from the MPEG-TS receiver 101, and transmits a decoded video signal to the displaying unit 103. Thus, the displaying unit 103 displays a broadcast content.

The uploading unit 104 uploads the MPEG-TS received by the MPEG-TS receiver 101 or a data packet stream of the MPEG-TS on the IPTV service server 120 via the IP network interface unit 105 and the IP network 110. The IP network interface unit 105 enables bidirectional communication between the hybrid IPTV 100 and the IPTV service server 120 via the IP network 110.

The UI 106 transmits and receives information between a user and the hybrid IPTV 100. Via the UI 106, a user may input an IPTV program guide information request signal related to a broadcast content which the user is presently watching and listening to. The IPTV program guide information request signal may be defined as an IPTV service information request signal.

When the IPTV program guide information request signal is received via the UI 106, the UI 106 provides information related to a TV channel which the user is presently watching to the IPTV service information transceiver 108. When the IPTV service information request signal is received via the UI 106, the user and device managing module 107 provides user identification information to the IPTV service information transceiver 108. The user and device managing module 107 may store user and device managing information such as user identification information, device state information and device identification information, and may output the user and device managing information whenever the user and device managing information is requested.

The IPTV service information transceiver 108 transmits user information including the user identification information and channel information to the IPTV service server 120 via the IP network interface unit 105 and the IP network 110. Then, when IPTV service information, that is, IPTV program guide information is received from the IPTV service server 120, the IPTV service information transceiver 108 displays the received IPTV program guide information on the displaying unit 103.

The received IPTV program guide information is related to the broadcast content which a user is presently watching. For example, if a user is presently watching a broadcast content A, and the broadcast content A is a serial program, the received IPTV program guide information may include program guide information regarding the serial program based on the broadcast content A which the user is presently watching. In addition, if the user is presently watching a broadcast content B, the IPTV program guide information displayed by the IPTV service information transceiver 108 may include program guide information regarding another broadcast content that is provided by another channel at the same time as the broadcast content B. The IPTV program guide information provided by the IPTV service server 120 may be determined according to the user identification information and user preference information, and the program guide information detected from the MPEG-TS uploaded from the hybrid IPTV 100.

The displaying unit 103 may display the received IPTV program guide information on a screen on which the broadcast content that the user is presently watching is reproduced so that the received IPTV program guide information and the broadcast content may overlap each other.

The uploading unit 104 of the hybrid IPTV 100 may be selectively operated by the user. That is, if the user does not want to upload the MPEG-TS, the uploading unit 104 may not operate. Thus, the IPTV service server 120 may provide a compensation service according to uploading the MPEG-TS to the user of the hybrid IPTV 100.

The IPTV service server 120 detects electronic program guide (EPG) information from the MPEG-TS uploaded via the IP network 110 so as to create a program guide database 122. When a user query for requesting the IPTV program guide information is received via the IP network 110, the user preference information is determined according to user information contained in the received user query, personalized IPTV service information is generated by searching the program guide database 122 according to the determined user preference information and the user information, and the personalized IPTV service information is provided to the hybrid IPTV 100 via the IP network 110.

As illustrated in FIG. 1, the IPTV service server 120 includes an uploading processor 121, the program guide database 122, a user query processor 123, an IPTV service information generator 124, and a user preference profile 125.

The uploading processor 121 receives the MPEG-TS uploaded via the IP network 110, and detects the EPG information from the received MPEG-TS so as to create the program guide database 122. The program guide database 122 may be created so as to divide the program guide information according to localities, times and services. In addition, a program and system information protocol (PSIP) for guiding an electronic program, service information (SI) and meta data are detected from the MPEG-TS so as to create the program guide database 122 that may provide the program guide information including information regarding a program event, a program level, and a standard time, as well as watching channel information. The meta data is data for indicating detailed information regarding a program, and may be, for example, data regarding a summarized content of the program.

Thus, the IPTV service server 120 may collect the program guide information regarding the broadcast content without receiving the EPG information regarding the broadcast content from a broadcasting station.

When the IPTV service information is requested via the IP network 110, the user query processor 123 transmits the IPTV service information request to the IPTV service information generator 124. Then, the IPTV service information generator 124 searches the user preference profile 125 for user preference information by using the user identification information contained in the received IPTV service information request. The user preference profile 125 may be previously set based on information obtained by monitoring an operation of the hybrid IPTV 100, may be previously set by a system operator of the IPTV service server 120, or may be previously set based on the user preference information provided by the hybrid IPTV 100. The user preference information may include, for example, information regarding a genre, a watching time, a broadcasting channel, or an actor of a broadcast content that a user watches frequently.

When the user preference information is searched, the IPTV service information generator 124 searches the program guide database 122 according to the user preference information and the channel information related to broadcast content that a user is presently watching, and generates the personalized IPTV program guide information that is based on user information. Thus, the personalized IPTV program guide information is related to the broadcast content that the user is presently watching, as described above, and includes IPTV program guide information based on the user preference information.

The personalized IPTV program guide information is transmitted to the hybrid IPTV 100 via the user query processor 123 and the IP network 110.

Thus, the hybrid IPTV 100 may request the IPTV service server 120 for the IPTV program guide information, and then may provide, to the user, the IPTV program guide information based on the user preference information, which is related to the broadcast content that the user is presently watching, rather than performing a separate information detection process or an information processing process. Thus, the hybrid IPTV 100 may be embodied easily. The hybrid IPTV 100 may be defined as a broadcasting receiver linked to a web service and a digital broadcasting network.

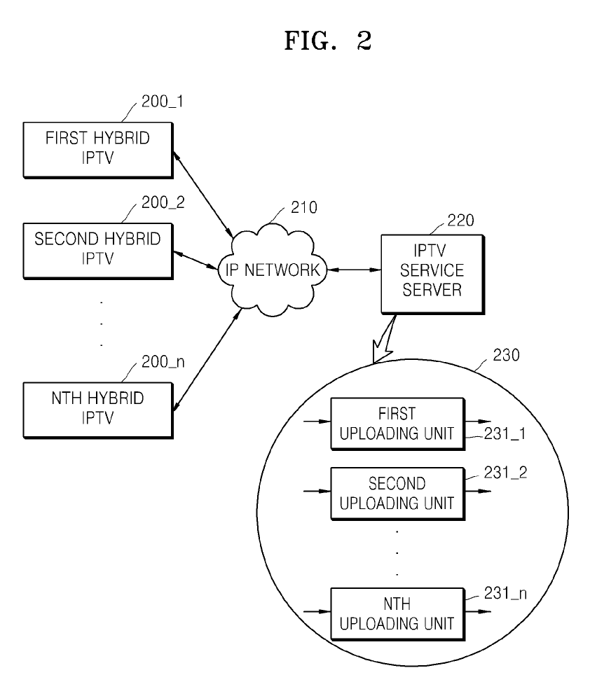

FIG. 2 is a structural view of a network containing first through n-th hybrid IPTVs 200_1 through 200_{—}n and an IPTV service server 220, according to an exemplary embodiment.

Referring to FIG. 2, the first through n-th hybrid IPTVs 200_1 through 200_{—}n may be hybrid IPTVs receiving MPEG-TSs in the same broadcasting manner, or alternatively may be hybrid IPTVs receiving MPEG-TSs in different broadcasting manners. For example, the first hybrid IPTV 200_1 receives an MPEG-TS in a US broadcasting manner, the second hybrid IPTV 200_2 receives an MPEG-TS in a European broadcasting manner, and the n-th hybrid IPTV 200_{—}n receives an MPEG-TS in the same broadcasting manner as in a portable digital multimedia broadcasting (DMB).

When the first through nth hybrid IPTVs 200_1 through 200_{—}n receive MPEG-TSs in different broadcasting manners, an uploading unit 230 included in the IPTV service server 220 may include first through n-th uploading units 231_1 through 231_{—}n which respectively correspond to the first through n-th hybrid IPTVs 200_1 through 200_{—}n, as illustrated in FIG. 2. Thus, the IPTV service server 220 may analyze broadcasting programs included in the MPEG-TSs transmitted in the different broadcasting manners that are globally uploaded, and may provide the personalized IPTV service information, which has been described with reference to FIG. 1, based on a result of the analysis.

The first through n-th hybrid IPTVs 200_1 through 200_{—}n may each be the same as the hybrid IPTV 100 of FIG. 1, and the IPTV service server 220 may be the same as the IPTV service server 120 of FIG. 1 except for the uploading unit 230.

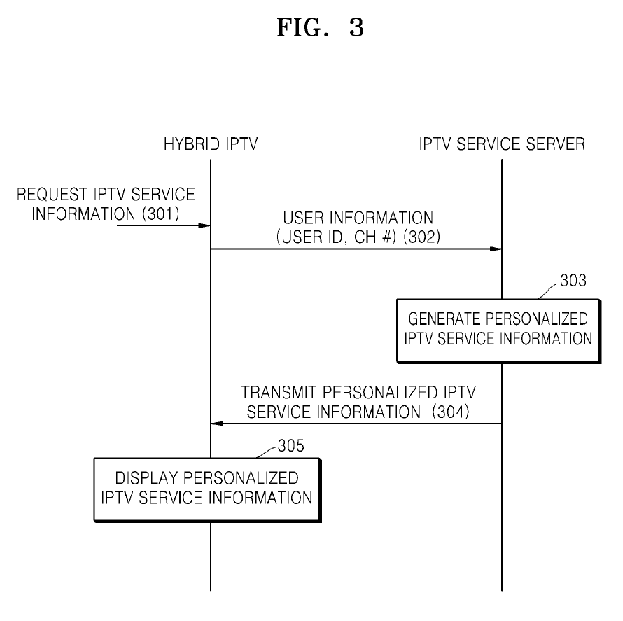

FIG. 3 is an operational flowchart of a method of providing IPTV service information, according to an exemplary embodiment.

Referring to FIG. 3, when a hybrid IPTV user requests IPTV service information (operation 301), user information is transmitted from a hybrid IPTV to an IPTV service server (operation 302). At this time, the user information includes user identification information and channel information of a broadcast content that the user is presently watching. In addition, IPTV service information request may be defined as an IPTV program guide information request.

Then, the IPTV service server may generate personalized IPTV service information (operation 303). The personalized IPTV service information is generated based on EPG information detected from an MPEG-TS received from at least one hybrid IPTV, user preference information, and channel information of the broadcast content that the user is presently watching.

The IPTV service server transmits the personalized IPTV service information to the hybrid IPTV (operation 304). The hybrid IPTV displays the personalized IPTV service information (operation 305). At this time, the hybrid IPTV may display the personalized IPTV service information on a screen on which the broadcast content that the user is presently watching is reproduced so that the personalized IPTV service information and the broadcast content may overlap each other.

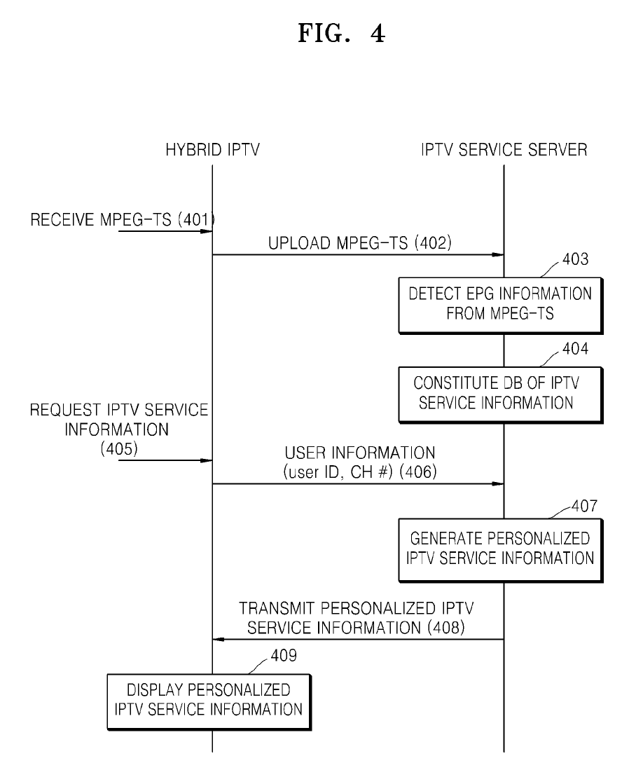

FIG. 4 is an operational flowchart of a method of providing IPTV service information, according to another exemplary embodiment. The method of FIG. 4 may further include transmitting or uploading the MPEG-TS received in the method of FIG. 3 on the IPTV service server.

Referring to FIG. 4, when the MPEG-TS is received (operation 401), the hybrid IPTV transmits or uploads the MPEG-TS on the IPTV service server (operation 402).

The IPTV service server detects the EPG information from the MPEG-TS (operation 403). For example, a program and system information protocol (PSIP), service information (SI) and meta data are detected from the MPEG-TS so as to create a database that may manage the EPG information according to localities, times and services (operation 404).

When the IPTV service information is requested (operation 405), the hybrid IPTV transmits the user information to the IPTV service server (operation 406). Then, the IPTV service server generates the personalized IPTV service information (operation 407), and transmits the personalized IPTV service information to the hybrid IPTV (operation 408). The hybrid IPTV displays the personalized IPTV service information (operation 409).

According to the present exemplary embodiment, in the method of providing IPTV service information, program guide information may be detected from an MPEG-TS uploaded from hybrid IPTVs receiving MPEG-TSs in different broadcasting manners as illustrated in FIG. 2, a database of the program guide information may be created based on the program guide information, and then personalized IPTV service information may be generated.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A method of providing Internet protocol television (IPTV) service information, the method comprising:
transmitting user information to an IPTV service server via an Internet protocol (IP) network;
receiving personalized IPTV service information that is based on the user information from the IPTV service server; and
displaying the personalized IPTV service information.

2. The method of claim 1, further comprising transmitting a transport stream to the IPTV service server via the IP network.

3. The method of claim 2, wherein the displaying comprises displaying the personalized IPTV service information on a screen on which a content is reproduced so that the personalized IPTV service information and the content overlap each other.

4. The method of claim 2, wherein the user information comprises user identification information and channel information about a broadcast content that a user is presently watching and comprises the transport stream.

5. The method of claim 2, wherein the personalized IPTV service information comprises program guide information generated from EPG information detected from the transport stream uploaded from at least one hybrid IPTV, according to a user preference profile.

6. The method of claim 1, wherein the displaying comprises displaying the personalized IPTV service information on a screen on which a content is reproduced so that the personalized IPTV service information and the content overlap each other.

7. The method of claim 4, wherein the content reproduced is a broadcast content that a user is presently watching.

8. The method of claim 1, wherein the user information comprises user identification information and channel information about a broadcast content that a user is presently watching.

9. The method of claim 7, wherein the personalized IPTV service information comprises program guide information generated from electronic program guide (EPG) information detected from a transport stream, corresponding to the broadcast content, uploaded from at least one hybrid IPTV, according to a user preference profile and the channel information.

10. The method of claim 1, wherein the personalized IPTV service information comprises program guide information generated from EPG information detected from a transport stream uploaded from at least one hybrid IPTV, according to a user preference profile.

11. A hybrid Internet protocol television (IPTV) comprising:
an IP network interface unit;
an IPTV service information transceiver that transmits user information to an IPTV service server via the IP network interface unit and an IP network, and receives personalized IPTV service information that is based on the user information from the IPTV service server through the IP network; and
a displaying unit that displays the personalized IPTV service information received by the IPTV service information receiver.

12. The hybrid IPTV of claim 11, further comprising:
a receiver that receives a transport stream; and
an uploading unit that uploads the transport stream received by the receiver on the IPTV service server via the IP network interface unit and the IP network.

13. The hybrid IPTV of claim 12, further comprising a decoder that decodes the transport stream received by the receiver,
wherein the displaying unit displays the personalized IPTV service information on a screen on which a broadcast content, comprising the transport stream, output from the decoder is reproduced so that the personalized IPTV service information and the broadcast content overlap each other.

14. The hybrid IPTV of claim 11, wherein the user information comprises user identification information and channel information about a broadcast content that a user is presently watching.

15. The hybrid IPTV of claim 14, wherein the personalized IPTV service information comprises program guide information generated from EPG information detected from a transport stream uploaded from at least one hybrid IPTV, according to a user preference profile and the channel information.

16. The hybrid IPTV of claim 11, wherein the personalized IPTV service information comprises program guide information generated from EPG information detected from a transport stream uploaded from at least one hybrid IPTV, according to a user preference profile.

17. A computer readable recording medium having recorded thereon a program for executing a method of providing Internet protocol television (IPTV) service information, the method comprising:
transmitting user information to an IPTV service server via an Internet protocol (IP) network;
receiving personalized IPTV service information that is based on the user information from the IPTV service server; and
displaying the personalized IPTV service information.

18. The computer readable recording medium of claim 17, further comprising transmitting a transport stream to the IPTV service server via the IP network.

19. The computer readable recording medium of claim 17, wherein the user information comprises user identification information and channel information related to a broadcast content that a user is presently watching,
wherein the personalized IPTV service information comprises personalized IPTV program guide information.

20. An Internet protocol television (IPTV) comprising:
a display unit that displays a content received at the display unit; and
an IPTV service information transceiver that transmits first information on the content to an external IPTV service server, and, in response, receives second information on the content,
wherein the display unit displays the second information along with the content if the second information is received.

21. The IPTV of claim 20, further comprising a receiver that receives the content from an external source through at least one of a terrestrial public network, a satellite network and a cable network, and
wherein the IP TV is connected to the external IPTV service server through an IP network.

22. The IPTV of claim 20, wherein the first information comprises at least one of information on a user, information on the IPTV and information on a channel of the content.

23. The IPTV of claim 22, wherein the second information further comprises information on preference of the user.
